(19) United States
(12) Patent Application Publication
(10) Pub. No.: US 2009/0254467 A1
(43) Pub. Date: Oct. 8, 2009

(54) PERSONAL FINANCE PLANNER FOR MOBILE COMMUNICATIONS DEVICE

(76) Inventor: William O. CAMP, JR., Chapel Hill, NC (US)

Correspondence Address: HARRITY & HARRITY, LLP, 11350 RANDOM HILLS ROAD, SUITE 600, FAIRFAX, VA, 22030, US

(21) Appl. No.: 12/062,021

(22) Filed: Apr. 3, 2008

(51) Int. Cl. G06Q 40/00

(52) U.S. Cl. 705/35

(57) ABSTRACT

Disclosed is a method, system, and computer readable medium for managing and tracking personal financial information on a mobile communications device. The cost of an item to be purchased is input into the mobile communications device. The cost is then applied to one or more current financial metrics associated with a user of the mobile communications device. A change in the one or more financial metrics is calculated. The changes in the one or more financial metrics are then presented using a display and/or a speaker.

### SUMMARY

Disclosed is a method, system, and computer readable medium for managing and tracking personal financial information on a mobile communications device. The cost of an item to be purchased is input into the mobile communications device. The cost is then applied to one or more current financial metrics associated with a user of the mobile communications device. A change in the one or more financial metrics is calculated. The changes in the one or more financial metrics are then presented using a display and/or a speaker.

Entering the cost of an item to be purchased into the mobile communications device can be accomplished in a variety of ways. A near field communication (NFC) RF device or a bar code scanning device that is integrated or attached to the mobile communications device can be used to read a transponder tag or a bar code containing cost information for the item. A camera module that is integrated or attached to the mobile communications device in conjunction with an optical character recognition can be used to recognize cost information for the item. A touchscreen display can be used to receive manual input associated with the cost of the item. Or, a keypad/keyboard can be used to receive manual input associated with the cost of the item.

The financial metrics can include, but are not limited to, a home budget, a retirement plan, an account balance, and a net worth. Calculating a change in the financial metrics entails determining a current value for a financial metric, applying the cost of the item to the current value for the financial metric, and calculating a changed value for the financial metric based on the cost of the item.

Presenting the changes in the financial metrics can be a visual and or audible interactive experience that can utilize graphs, icons, audio clips, video clips, to describe the change in the financial metric as well as an avatar (animated or non-animated) to describe the change in the financial metric.

Some of the calculations can be performed on a remote computing device outside of the mobile communications device. The cost data can be transmitted from the mobile phone to such a remote computing device over a network connection. Then, applying the cost of the item to one or more current financial metrics associated with a user of the mobile communications device and calculating a change in the one or more financial metrics can be performed on the remote computing device. The results of the calculations can then be received over a network connection from the remote computing device. This embodiment allows much of the user's personal financial information to remain on a different device such that the mobile communications device transmits the cost and provides the interactive display of results.

### BRIEF DESCRIPTION OF THE DRAWINGS

FIG. 1 describes a network environment that can be used with one embodiment of the invention.

FIG. 2 is an illustration of some of the internal components of a mobile communications device.

FIG. 3 is a data flow diagram describing processes of embodiments of the present invention.

FIG. 4 is an example screen display of the results of a purchase for one example of an embodiment of the invention.

FIG. 5 is another example screen display of the results of a purchase for one example of an embodiment of the invention.

FIG. 6 is another example screen display of the results of a purchase for one example of an embodiment of the invention.

FIG. 7 is another example screen display of the results of a purchase for one example of an embodiment of the invention.

### DETAILED DESCRIPTION OF THE INVENTION

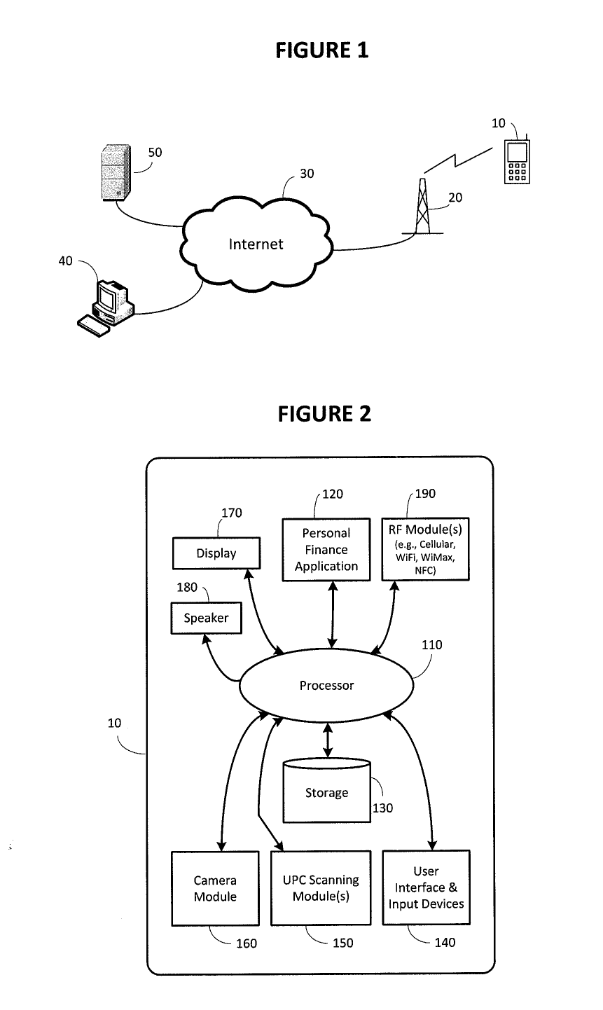

FIG. 1 describes a network environment that can be used with one embodiment of the invention. A mobile communications device 10 is communicable with a network 30 (e.g., Internet) via a basestation/mobile network interface 20. Once connected with the Internet 30, the mobile communications device 10 can establish further connections with other computing devices that are also connected with the Internet 30. This can include, for instance, a home computer 40 or a 3^{rd} party remote server 50.

FIG. 2 is an illustration of some of the internal components of a mobile communications device 10. Within the mobile communications device 10 there are included several components that operate to practice the embodiments of the invention. Not all the components that comprise a mobile communications device 10 are illustrated, however.

A processor 110 serves to coordinate and control the operations and interactions among the various components. A personal finance application 120 is executed by the processor to monitor and track the status of a user's personal finances and the impact that each new contemplated purchase will have on various aspects of the user's financial status. To help monitor and track the user's financial status, a variety of user interface and input devices 140 are used to input the cost of a contemplated purchase into the mobile communications device 10. Some of these input devices 140 can include, but are not limited to, a keypad/keyboard, scroll wheels, touchscreen, near field communication (NFC) transponders, and a microphone. A barcode scanner 150 may also be included to read bar code data of potential purchase items. A camera module 160 may also be utilized to take a picture of a price tag or bar code. The resulting image can be analyzed by another software application to recognize the price listed on the price tag or to decode the bar code to obtain the price information.

These components serve as the tools by which a user can input data to the personal finance application 120. A display 170 and a speaker 180 can be utilized to present data results generated by the personal finance application 120.

The mobile communications device 10 also includes one or more RF modules 190 for sending and receiving voice, audio, or data wirelessly to and from the mobile communications device 10. The RF modules 190 can be both near field communication (NFC) RF protocols such as, for instance, RFID tagging or Bluetooth™, as well as longer range RF protocols such as, for instance, 802.11 WiFi systems, WiMax systems, and even longer range cellular data protocols (e.g., GPRS, EDGE, EV-DO, HSDPA, UMTS, etc.) for connecting to a network such as the Internet. The short range RF systems can be utilized to acquire price data from an item while the longer range RF systems can be utilized to convey data across a network for remote processing. One or more data storage devices 130 are also included within the mobile communications device 10 for storing the software components as well as input data and output results.

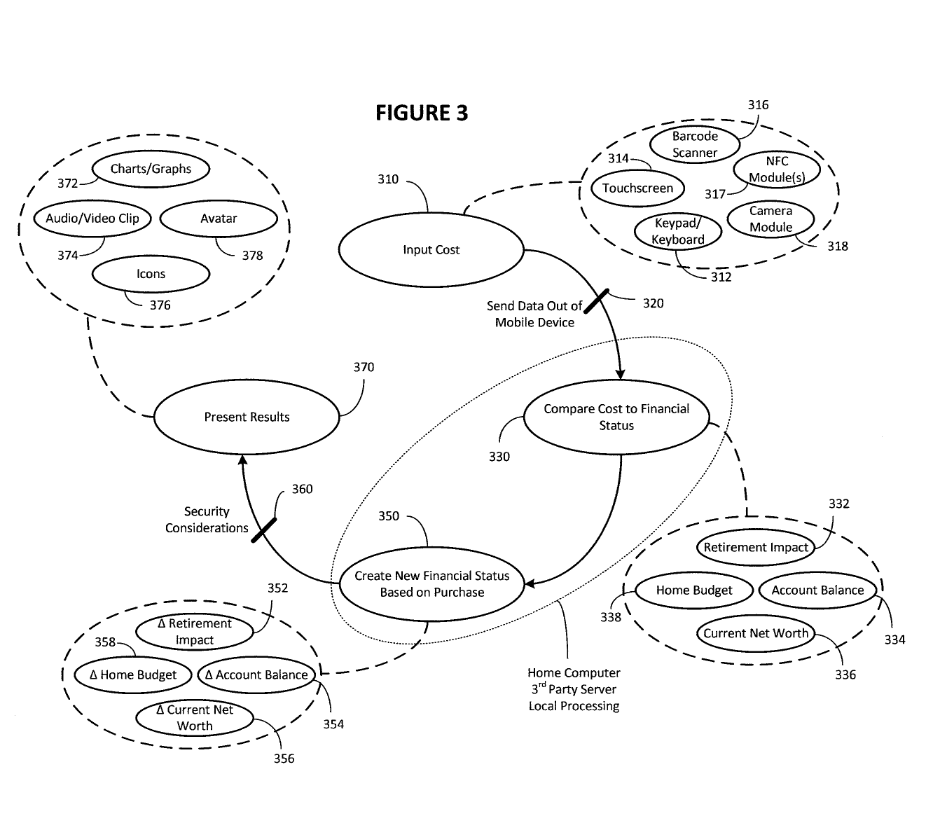

FIG. 3 is a data flow diagram describing processes of embodiments of the present invention. The invention embodiments can be broken down into four major processes. They include an input cost 310 process, a compare cost to financial status 330 process, a create new financial status based on purchase 350 process, and a present results process 370. These processes collectively provide a user with the ability to perceive the potential impact a contemplated purchase will have on a variety of personal financial metrics. The contemplated purchase can be rather small, such as a cup of coffee and its impact on a weekly cash budget. Or, the purchase could be rather large, such as a new automobile and its impact to overall net worth and debt/equity relationships.

At its essence, the user will input the cost of an item 310 to his mobile communications device 10. The personal finance application 120 hosted by the mobile communications device 10 will then apply and compare the cost 330 to a variety of appropriate financial metrics. Once the numbers have been processed, the personal finance application 120 will update the user's financial status 350 as if the user has made the purchase. The personal finance application 120 in conjunction with the output devices associated with the mobile communications device 10 will then present the results 370 of the calculations and impact to the user's financial status using a variety of interactive, graphical, or iconic means. The user can then make an informed decision whether to proceed or not with the contemplated transaction.

Each major process encompasses one or more methods or tools for implementing the process. Referring to the input cost process 310, there are a multiple methods and tools for inputting the cost of an item so that it can be used by the personal finance application 120. Items that can be considered “stock” or “off the shelf” most often include a bar code or universal product code (UPC) either on the item's packaging or on a display unit associated with the item. The mobile communications device 10 can include a barcode scanner application 316 capable of reading and interpreting the bar code data. Another method of inputting cost data is through the use of near field communications (NFC). An NFC module 317 can communicate with a very small NFC transponder associated with an item of interest. When the personal finance application is active, the NFC module can be open to transponder signals that contain cost information. The mobile communications device 10 may also include a camera module 318 and associated application in which a photographic image of a “price tag” or bar code can be analyzed using a character recognition algorithm to discern the price of an item or a bar code recognition algorithm to recognize and interpret a bar code. The mobile communications device 10 may also include a touchscreen 314 capable of accepting manual input from the user. Or, the mobile communications device 10 may include one or more keypads/keyboards 312 also capable of accepting manual input from the user. Any of the above methods or tools may be utilized to input the cost of an item so that the personal finance application 120 can determine the potential impact of such purchase.

Once the data is input into the personal finance application 120 within the mobile communications device 10 it can be processed. Processing can be localized provided enough of a user's personal financial information is stored locally by the mobile communications device 10. Or, the cost data can be transmitted 320 out of the mobile communications device 10 over a network to a destination computing device (e.g., home computer 40 or 3^{rd} party server 50) where it can be processed.

There can be a variety of financial metrics that are impacted by a potential purchase. The personal finance application 120 applies the cost to financial status process 330. The application of the cost of an item to the user's financial status can affect one or more of the user's home budget 338, one or more account balances 334, current net worth 336, and even impact on retirement savings 332. There may be other financial metrics that could be included within the non-exhaustive list above without departing from the scope of the invention embodiments.

Once the cost data has been applied and analyzed, the personal finance application 120 constructs an updated financial status 350 to reflect the impact of the purchase, if made. The updated financial status will calculate delta (Δ) values for each of the financial metrics including, but not limited to, Δ home budget 358, one or more Δ account balances 354, Δ current net worth 356, and Δ retirement savings 352.

If these values have been remotely processed they will be returned to the mobile communications device 10 over a network connection. Since the information may be considered sensitive, one or more security techniques 360 such as encryption may be used. Moreover, the values can be sent in their Δ format which, without context, provides some level of security. The updated financial status may also be sent in its entirety (i.e., not just Δ values).

Once the updated financial status has been either locally calculated by the personal finance application or returned to the mobile communications device 10 from remote computing device, the results can be presented to the user 370. Presenting the results of a calculation to the user can be done in an entertaining yet informative manner. The embodiments of the invention utilize a variety of output devices and formats to provide the user with pertinent information in an entertaining easy to understand and intuitive manner so as to facilitate the user's decision regarding a purchase. Some of the devices, tools, and methods used to present results include, but are not limited to, charts and graphs 372 (color when possible), audio/video clips 374, icons 376, and avatars (animated or non-animated) 378. Any of the above can be combined to provide an even greater interactive experience.

Several example scenarios are described below to illustrate some of the capabilities and presentation features of the embodiments of the invention.

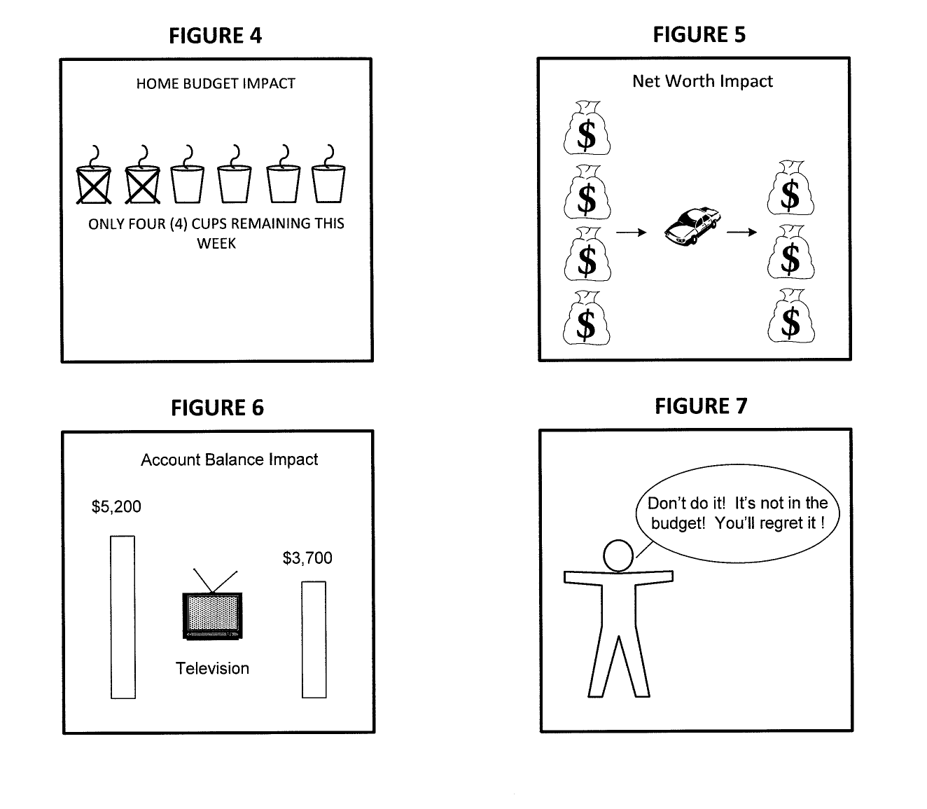

FIG. 4 is an example screen display of the results of a purchase for one example of an embodiment of the invention. In this example, the display shows an image of six (6) cups of coffee under a heading of home budget. Two of the cups of coffee have been crossed out to indicate that the user has already purchased two of the allotted cups of coffee for the week. Presumably, the user has created a home budget that allows for the purchase of six cups of coffee per week. Each time the user purchases a cup of coffee and that transaction is entered, another icon is crossed out and a caption tells the user how many remaining cups he may purchase this week. In addition to a visual reminder, there can be a complementary audio reminder via a speaker output telling the user of the current status. This is but one example of how the user can manage and update a home budget. Other items on typically associated with a home budget including, but not limited to, utility bills, groceries, gas, rent (or mortgage), and insurance premiums may also be tracked and managed.

FIG. 5 is another example screen display of the results of a purchase for one example of an embodiment of the invention. In this example, the user is contemplating the purchase of an automobile and the effect it will have on his net worth. The display graphically shows an iconic representation of the user's current net worth on the left side of the screen. The automobile is illustrated in the center of the display followed by a second iconic representation of the user's current net worth should he proceed with the purchase. The icons can be labeled with actual dollar values to show a true cost and/or the net worth can be displayed as a percentage to indicate a difference that will result from the purchase. The user may have set limits around the purchase that will warn when the purchase reduces net worth by more than 10%. If this is the case, the iconic column on the right may be highlighted in red to indicate the perceived negative effect. If the purchase is in-line with specified tolerances, the iconic column on the right could be highlighted in green to indicate that it is okay to make the purchase.

Since an automobile is likely considered a major purchase, the transaction could also have a noticeable effect on retirement savings. While this example does not provide a visual display of the effects to retirement savings, one of ordinary skill in the art could readily contemplate such a display should the user choose to present that particular financial metric.

FIG. 6 is another example screen display of the results of a purchase for one example of an embodiment of the invention. In this example, the user is contemplating the purchase of a new television set and the effect it will have on his overall account balance in the account that will be used to cover the purchase. The account can include a checking account, a credit card account, a savings account or a combination of the aforementioned. Similar to the previous example an bar graph on the left side of the screen indicates a value associated with one or more accounts. The television is illustrated in the middle of the display to show what may be purchased and the bar graph on the right indicates the effect of purchase on the accounts. The visual presentation of the data may be more intuitive to the user and provide more of an impact to the decision making process.

FIG. 7 is another example screen display of the results of a purchase for one example of an embodiment of the invention. This illustration can be utilized with the three previous examples as a follow on screen when the user has exceeded pre-defined tolerances or limits. It shows an image of an avatar and a callout box with dialogue. Specifically, the avatar is frantically trying to prevent the user from making the purchase because it violates one of the tolerances specified by the user. The avatar can be animated with movement for more emphasis. For instance, referring back to FIG. 4, suppose the user had already purchased his allotted six cups of coffee for the week and was considering a seventh. The display of FIG. 4 would show all six cups crossed out followed by the image of the avatar in FIG. 7. The same goes for the examples in FIGS. 5 and 6 if the proposed purchase violates one or more user defined tolerances on one or more financial metrics. FIG. 7 illustrates an avatar trying to dissuade a user from making a purchase. An avatar could also be utilized in a happier setting to inform the user that the proposed purchase is acceptable. This could be, for instance, an image of the avatar jumping up and down with a big smile.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Any prompts associated with the present invention may be presented and responded to via a graphical user interface (GUI) presented on the display of the mobile communications device or the like. Prompts may also be audible, vibrating, etc.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A method of managing and tracking personal financial information on a mobile communications device that includes a bar code scanner or a camera with pattern recognition, the method comprising:
determining, by the mobile communications device, the cost of an item to be purchased, by one or more of:
scanning, with the bar code scanner, a bar code containing cost information for the item, or
capturing, with the camera, an image of a cost associated with the item or a bar code containing cost information associated with the item and recognizing cost information for the item using the pattern recognition;
applying the determined cost of the item to one or more financial metrics associated with a user of the mobile communications device;
calculating changes in the one or more financial metrics based on applying the determined cost of the item; and
presenting the changes in the one or more financial metrics via one or more of a display or a speaker.

2. (canceled)

3. The method of claim 1, where the one or more current financial metrics include at least one of a home budget, a retirement plan, an account balance or a net worth.

4. The method of claim 1, where calculating changes in the one or more financial metrics comprises:
determining a current value for the one or more financial metrics
applying the cost of the item to the current value for the one or more financial metrics; and
calculating changes in the current value of the one or more financial metrics based on the cost of the item.

5. The method of claim 4, where presenting the changes in the one or more financial metrics via one or more of a display or a speaker comprises one or more of:
utilizing graphs to present the changes in the one or more financial metrics;
utilizing icons to present the changes in the one or more financial metrics;
utilizing audio clips to present the changes in the one or more financial metrics;
utilizing video clips to present the changes in the one or more financial metrics;
utilizing an avatar to describe the changes in the one or more financial metrics; or
utilizing an animated avatar to describe the changes in the one or more financial metrics.

6. The method of claim 1 further comprising:
transmitting data regarding the cost from the mobile communications device to a remote computing device over a network connection, where applying the cost of the item to the one or more current financial metrics associated with user of the mobile communications device and calculating changes in the one or more financial metrics are executed by the remote computing device.

7. The method of claim 6, further comprising receiving the changes in the one or more financial metrics over a network connection from the remote computing device.

8. A computer-readable memory device to store one or more instructions to manage and track personal financial information on a mobile communications device, the computer-readable memory device comprising:
one or more instructions to determine the cost of an item to be purchased, by one or more of:
scanning, with a bar code scanner, a bar code containing cost information for the item, or
capturing, with a camera, an image of a cost associated with the item or a bar code containing cost information associated with the item and recognizing cost information for the item using pattern recognition;
one or more instructions to apply the determined cost of the item to one or more current financial metrics associated with a user of the mobile communications device;
one or more instructions to calculate changes in the one or more financial metrics; and
one or more instructions to present the changes in the one or more financial metrics using one or more of a display or a speaker.

9. (canceled)

10. The computer-readable memory device of claim 8, the one or more current financial metrics include at least one of:
a home budget, a retirement plan, an account balance, or a net worth.

11. The computer-readable memory device of claim 8, where the one or more instructions to calculate changes in the one or more financial metrics further comprises:
one or more instructions to determine a current value for the one or more financial metrics;
one or more instructions to apply the cost of the item to the current value for the one or more financial metrics; and
one or more instructions to calculate changes in the current value of the one or more financial metrics based on the cost of the item.

12. The computer-readable memory device of claim 11, where the one or more instructions to present the changes in the one or more financial metrics using one or more of a display or a speaker further comprises
one or more instructions to utilize graphs to present the changes in the one or more financial metrics;
one or more instructions to utilize icons to present the changes in the one or more financial metrics;
one or more instructions to utilize audio clips to present the changes in the one or more financial metrics;
one or more instructions to utilize video clips to present the changes in the one or more financial metrics;
one or more instructions to utilize an avatar to describe the changes in the one or more financial metrics; or
one or more instructions to utilize an animated avatar to describe the changes in the one or more financial metrics.

13. The computer-readable memory device of claim 8, further comprising:
one or more instructions to transmit the cost data from the mobile communications device to a remote computing device over a network connection, where the one or more instructions to apply the cost of the item to one or more current financial metrics associated with the user of the mobile communications device and the one or more instructions to calculate changes in the one or more financial metrics are executed by the remote computing device.

14. The computer-readable memory device of claim 13, further comprising one or more instructions to receive the changes in the one or more financial metrics over a network connection from the remote computing device.

15. A system for managing and tracking personal financial information on a mobile communications device, the system comprising:
a memory device to store one or more instructions;
one or more processors to execute the one or more instructions to cause the processor to:
determine the cost of an item to be purchased, by one or more of:
scanning, with a bar code scanner, a bar code containing cost information for the item, or
capturing, with a camera, an image of a cost associated with the item or a bar code containing cost information associated with the item and recognizing cost information for the item using pattern recognition;
apply the determined cost of the item to one or more financial metrics associated with a user of the mobile communications device:
calculate changes in the one or more financial metrics; and
present the changes in the one or more financial metrics using one or more of a display or a speaker connected to the processor; and
one or more RF modules coupled with the processor to send and receive data

16. The system of claim 15 further comprising a near field communication
(NFC) module that can communicate with an NFC transponder to receive cost information for the item.

17. (canceled)

18. (canceled)

19. The system of claim 15, where the one or more instructions to cause the processor to determine the cost of an item to be purchased further includes: one or more instructions to cause the processor to utilize a touchscreen display to receive manual input associated with the cost of the item.

20. The system of claim 15, where the one or more instructions to cause the processor to determine the cost of an item to be purchased further includes:
one or more instructions to cause the processor to utilize a keypad/keyboard to receive manual input associated with the cost of the item.

21. The system of claim 15, where the one or more financial metrics include at least one of a home budget, a retirement plan, an account balance or a net worth.

22. The system of claim 15, where causing the one or more processors to calculate changes in the one or more financial metrics comprises:
causing the one or more processors to determine a current value for the one or more financial metrics;
causing the one or more processors to apply the cost of the item to the current value for the one or more financial metrics; and
causing the one or more processors to calculate changes in the current value of the one or more financial metrics based on the cost of the item.

23. The system of claim 18, where causing the one or more processors to present the changes in the one or more financial metrics using one or more of a display or a speaker comprises one or more of:
causing the one or more processors to utilize graphs to present the changes in the financial metric;
causing the one or more processors to utilize icons to present the changes in the one or more financial metrics;
causing the one or more processors to utilize audio clips to present the changes in the one or more financial metrics;
causing the one or more processors to utilize video clips to present the changes in the one or more financial metrics;
causing the one or more processors to utilize an avatar to describe the changes in the one or more financial metrics; or
causing the one or more processors to utilize an animated avatar to describe the changes in the one or more financial metrics.

24. The system of claim 15, where the one or more processors is to execute one or instructions to cause the one or more processors to further comprising:
transmit the cost data from the mobile communications device to a remote computing device, including a processor of the one or more processors, using the one or more RF modules over a network connection where the processor is to apply the cost of the item to one or more current financial metrics associated with a user of the mobile communications device and calculate changes in the one or more financial metrics on the remote computing device.

25. The system of claim 20, where the one or more processors is to execute one or instructions to cause the one or more processors to:
receive the changes in the one or more financial metrics via the one or more RF modules over a network connection from a remote computing device.

26. The method of claim 1, where presenting the changes in the one or more financial metrics using one or more of a display or a speaker further include:
displaying a predetermined color on the display, based on the one or more financial metrics reaching a predetermined condition.
